(19) United States
(12) Patent Application Publication
(10) Pub. No.: US 2019/0331847 A1
(43) Pub. Date: Oct. 31, 2019

(54) PHOTONIC CRYSTAL FIBER METHODS AND DEVICES

(71) Applicant: SOCOVAR SOCIETE EN COMMANOITE, Montreal (CA)

(72) Inventor: Bora UNG, Verdun (CA)

(73) Assignee: Socovar Societe en Commandite, Montreal, QC (CA)

(21) Appl. No.: 16/310,689

(22) PCT Filed: Jun. 23, 2017
(86) PCT No.: PCT/CA2017/000157

§ 371 Date: Dec. 17, 2018

Related U.S. Application Data
(60) Provisional application No. 62/353,672, filed on Jun. 23, 2016.

(51) Int. Cl. G02B 6/02; C03B 37/027

(52) U.S. Cl. CPC G02B 6/02347; G02B 6/02385; C03B 2203/16; C03B 37/02781; C03B 2203/42; G02B 6/02328

(57) ABSTRACT

Orbital angular momentum (OAM) based photonics promises researchers and systems designers with a new degree of freedom whilst offering annular intensity distributions rather than Gaussian intensity distributions. However, absence of an optical fiber design that not only supports propagation of OAM signals and cylindrical vector modes but does so with a large design space for designers to adjust and tune the modal properties of the optical fiber supporting these OAM signals has hampered developments. Embodiments of the invention exploit photonic crystal fiber designs to support this design/manufacturing tunability whilst also supporting “endlessly single-radial order” modal regimes where the optical fiber is mono-annular over a wide range of optical wavelengths. Such optical fibers being able to support the transmission of a larger diversity of mono-annular modes (OAM or vector modes in nature, or otherwise) in a reliable manner and over a wider range of wavelengths than conventional silica optical fibers.

### CROSS-REFERENCE TO RELATED APPLICATIONS

This application claims as a 371 National Phase entry application the benefit of priority from PCT/CA2017/000,157 filed Jun. 23, 2017 entitled “Photonic Crystal Fiber Methods and Devices” which itself claims the benefit of priority from U.S. Provisional Patent Application 62/353,672 filed Jun. 23, 2016 entitled “Photonic Crystal Fiber Methods and Devices”, the entire content of each being incorporated herein by reference.

### FIELD OF THE INVENTION

This invention relates to photonic crystal optical fibers and more specifically to annular core photonic crystal optical fibers, cylindrical vector modes of annular core photonic crystal optical fibers and orbital angular momentum based optical and photonic devices exploiting same.

### BACKGROUND OF THE INVENTION

Optical fiber communications have evolved in the past forty years since the first commercially viable, long length, low attenuation optical fibers in 1970, from Corning Glass Works based upon the fundamental understanding of impurities by STC Laboratories in 1966, to become the ubiquitous solution for telecommunications companies to transmit telephone signals, Internet communication, and cable television signals from high volume, low cost, short-haul applications within Local Area Networks and Passive Optical Networks, such as Fiber-to-the-Home, through to highly engineered ultra-long haul transoceanic links that form an intercontinental network of over 250,000 km of submarine communications cable that by the mid-2000s offered a capacity of 2.56 Tb/s and has increased continuously since.

During this period engineers and scientists have repeatedly battled, conquered, re-encountered, and harnessed non-linear effects in optical fiber as one of unique characteristics of silica optical fibers is their relatively low threshold for nonlinear effects. This can be a serious disadvantage in optical communications, especially in wavelength-division multiplexing (WDM) systems, where many closely spaced channels propagate simultaneously, resulting in high optical intensities in the fiber. For instance, in a typical commercial 128-channel 10-Gb system, optical nonlinearities limit the power per channel to approximately −5 dBm for a total launched power of 16 dBm. Beyond this power level, optical nonlinearities can significantly degrade the information capacity of the system.

On the other hand, optical nonlinearities can be very useful for a number of applications, starting with distributed in-fiber amplification and extending to many other functions, such as wavelength conversion, multiplexing and demultiplexing, pulse regeneration, optical monitoring, and switching. In fact, the development of the next generation of optical communication networks is likely to rely on fiber nonlinearities in order to implement all-optical functionalities. The realization of these new networks will therefore require that one look at the tradeoff between the advantages and disadvantages of nonlinear effects in order to utilize their potential to the fullest.

Interest in nonlinear fiber optics developed with the rapid growth of optical-fiber communications in the early 1980s and has been strong for the past 25 years. Over that period, in excess of ten thousand journal articles and conference papers have been published on the subject, several subfields have also developed and each of them has become very specialized. Amongst these are new glasses and fiber geometries with the intention of providing highly nonlinear fibers (HNLFs) and, in particular, micro-structured fibers. These HNLFs provide different fiber parameters that are related to both the material or glass composition and fiber geometry and the interplay between the two.

Why are optical nonlinearities of such prominence in research and development for sixth and subsequent generations of fiber optic devices and communication systems? Despite the small nonlinear index of silica (n₂=2.6×10⁻¹⁶ cm²W⁻¹), there are two characteristics of the optical fiber that strongly enhance optical nonlinearities: the core size and the length of the fiber. Accordingly, optical fiber non-linearities are evident in very long optical fiber communication systems with or without optical amplifiers operating at multi-gigabit rates of lengths of kilometers to tens of kilometers. However, in order to implement a wide variety of all-optical devices, including optical switches and wavelength converters, using silica optical fiber the physical lengths of optical fiber that need to be employed are correspondingly of hundreds of meters, where high optical power can be applied, to tens of kilometers where typical optical powers in optical networks are employed. It would be beneficial to engineer optical fibers with higher non-linearities allowing the lengths of the optical fiber within such devices to be reduced and/or the operating power to the devices to be reduced.

Accordingly, within the prior art substantial research has been directed to identifying alternate approaches, including, but not limited to:
Narrow-Core Fibers with Silica Cladding—narrow core and high doping levels to reduce the effective mode area, A_{eff}, and thereby enhance the non-linearity γ, where γ=2πn₁/λA_{eff};
Tapered Fibers with Air Cladding—standard fibers are stretched such that the surrounding air acts as the cladding;
Micro-Structured Fibers—air holes introduced within the cladding through techniques such as photonic crystals, holey fibers, etc; and
Non-Silica Fibers—use a different material with large values of n₂.

More recently, the emergence of orbital angular momentum (OAM) based optics and photonics promises to afford researchers and ultimately systems designers with a new degree of freedom. For example, OAM multiplexing would provide a physical layer method for multiplexing signals carried by optical signals using the orbital angular momentum of photons so as to distinguish between the different orthogonal signals. OAM multiplexing can (at least in theory) access a potentially unbounded set of OAM quantum states, and thus offer a much larger number of channels, subject only to the constraints of real-world optics. At the same time OAM based optics offers potential benefits within photonic applications as diverse as optical tweezers to remote sensing. Recent progress has extended original microwave and RF OAM techniques in free space transmission into optical fibers.

OAM light beams and modes in optical fibers are characterized by a “donut-shaped” annular intensity distribution, in contrast to the more common Gaussian light beams. However, to date extending our understanding of OAM light-matter interactions into the non-linear domain has been largely unexplored and have been hampered by the availability of an optical fiber design that not only supports propagation of OAM signals and cylindrical vector modes but does so with a large design space for designers to adjust and tune the modal properties of the optical fiber supporting these OAM signals. Accordingly, it would be beneficial to provide researchers and system designers with an optical fiber design that supports this tunability to explore the shaping of nonlinear OAM light matter interactions within the optical fiber. It would also be beneficial for at least part of the design range of the optical fiber supporting OAM modes and cylindrical vector modes to support what is known as an “endlessly single-radial order” modal regime wherein the optical fiber is mono-annular (i.e. exhibits a single intensity ring), thus guaranteeing the robust transmission of cylindrical vector modes and OAM modes over a wide range of optical wavelengths. Such optical fibers being able to support the transmission a larger diversity of mono-annular modes (OAM or vector modes in nature, or otherwise) in a reliable manner and over a wider range of wavelengths than conventional silica optical fibers.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to provide photonic crystal optical fibers and more specifically to annular core photonic crystal optical fibers, cylindrical vector modes of annular core photonic crystal optical fibers and orbital angular momentum based optical and photonic devices exploiting same.

In accordance with an embodiment of the invention there is provided a device comprising:
a structure having a predetermined cross-section and extending perpendicular to the cross-section formed from a material;
a plurality of holes extending longitudinally through the structure forming a two-dimensional lattice; wherein
an annular ring is symmetrically disposed relative to a predetermined point within the structure by not forming holes within the region defined as the annular ring such that the annular ring has a higher refractive index than the regions inside and outside the annular ring.

In accordance with an embodiment of the invention there is provided a device comprising:
a medium formed from a first material having optical transmission within a predetermined wavelength range;
a first structure disposed at a predetermined point within the medium and extending along an axis of the medium;
a plurality of second structures disposed around the first structure, each second structure at a predetermined location defined by a two-dimensional lattice centered upon the first structure;
a plurality of third structures disposed around the plurality of second structures, each third structure at a predetermined location defined by the two-dimensional lattice.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIGS. 1A to 1C depict establishment of an exemplary geometry of an annular core (AC) photonic crystal fiber (PCF) (AC-PCF) according to an embodiment of the invention wherein a “core region” of an optical waveguide is formed by omitting one or more rings of holes in the triangular lattice PCF formed from holes of constant diameter on a constant pitch;

FIGS. 1D to IF depict exemplary geometries of annular core (AC) photonic crystal fiber (PCF) (AC-PCF) according to an embodiment of the invention wherein a “core region” of an optical waveguide is formed by omitting one or more rings of holes in the lattice of the PCF which has been formed from holes of varying diameters and/or varying pitch to tailor the AC-PCF modal properties;

FIG. 2A depicts optical intensity profiles of guided modes of an AC-PCF according to an embodiment of the invention at λ=1550 nm for d/Λ=0.33 and λ/Λ=0.60;

FIG. 2B depicts alternate geometries of AC-PCF fibers according to embodiments of the invention exploiting circular and polygonal cross-sections;

FIG. 2C depicts alternate geometries of AC-PCF fibers according to embodiments of the invention exploiting a varying number of rings of holes in conjunction with a singular annular ring;

FIG. 3A depicts the waveguide regimes for guided modes of an AC-PCF according to an embodiment of the invention;

FIG. 3B depicts the nonlinear parameters of the fundamental HE₁₁ mode of an AC-PCF according to an embodiment of the invention at A=1550 nm with silica composition within the endlessly single-radial order regime;

FIG. 3C depicts the nonlinear parameters of the annular TE01 mode of an AC-PCF according to an embodiment of the invention at λ=1550 nm with silica composition within the endlessly single-radial order regime;

FIG. 4 depicts the modal separation inside the LP₁₁ group for a silica d/Λ=0.33 AC-PCF for varying λ/Λ ratios at λ=1550 nm together with the group velocity dispersion (GVD) of the HE₂₁ mode; and

FIG. 5 depicts the numerical simulation of supercontinuum generation within a silica AC-PCF according to an embodiment of the invention pumped at λ=800 nm with femtosecond Gaussian pulses.

### DETAILED DESCRIPTION

The present invention is directed to photonic crystal optical fibers and more specifically to annular core photonic crystal optical fibers, cylindrical vector modes of annular core photonic crystal optical fibers and orbital angular momentum based optical and photonic devices exploiting same.

Within the following description reference may be made below to specific elements, numbered in accordance with the attached figures. The discussion below should be taken to be exemplary in nature, and not as limiting the scope of the present invention. The scope of the present invention is defined in the claims, and should not be considered as limited by the implementation details described below, which as one skilled in the art will appreciate, can be modified by replacing elements with equivalent functional elements or combination of elements. Within these embodiments reference will be made to terms which are intended to simplify the descriptions and relate them to the prior art, however, the embodiments of the invention should not be read as only being associated with prior art embodiments.

Optical Waveguide Core-Cladding Materials:

In this specification the inventors describe an approach to the design of photonic crystal fibers to provide cylindrical vector modes and orbital angular momentum modes for a range of applications. Within embodiments of the invention described below with respect to the Figures reference is made to so-called “holey fibers” or ‘hole-assisted fibers” which employ a plurality of “holes” within the fiber. However, such fibers form subsets of photonic-crystal fibers (PCFs) and Photonic Crystal Waveguides PCWs) which overall are a class of optical fiber based on the properties of photonic crystals. Through their ability to confine light either directly within hollow cores or with confinement characteristics not possible in conventional optical fiber, PCFs offer benefits in applications such as fiber-optic communications, fiber lasers, nonlinear devices, high-power transmission, highly sensitive gas sensors, and other areas. Typically define subsets of PCFs include, but are not limited to:
photonic-bandgap fiber—PCFs that confine light by band gap effects;
holey fiber—PCFs using air holes in their cross-sections;
hole-assisted fiber—PCFs guiding light by a conventional higher-index core modified by the presence of air holes; and
Bragg fiber—photonic-bandgap fiber formed by concentric rings of multilayer film.

Photonic crystal fibers may be considered a subgroup of a more general class of microstructured optical fibers, where light is guided by structural modifications, and not only by refractive index differences. Accordingly, depending upon operating wavelength range, desired optical characteristics, manufacturing methodology, deployment environment, cost, design, such PCFs may exploit a range of optically transparent glasses including, but not limited to, oxides, fluorides, phosphates, and chalcogenides together with other materials including, but not limited to amorphous alloys and nano-particles whilst the materials may further include engineered micro-structures. However, it would be evident that in other embodiments the optical glass may be replaced with a crystal, a plastic, a resin, a semiconductor material, a compound semiconductor, or other material meeting the design and performance requirements of the PCF.

Oxides:

The most common oxide glass for optical communications is silica which exhibits good optical transmission over a wide range of wavelengths, particularly in the near-infrared (near IR) portion of the spectrum around 1.5 μm where extremely low absorption and scattering losses result in attenuation of the order of 0.2 dB/km. High transparency in the 1.4-μm region can be achieved through ensuring a low concentration of hydroxyl groups (OH). Alternatively, a high OH concentration is better for transmission in the ultraviolet (UV) region. Silica may be doped with various materials, such as for modifying refractive index, for example raising it with germanium dioxide (GeO2) or aluminum oxide (Al2O3) or lowering it with fluorine or boron trioxide (B2O3).

Doping is also possible with laser-active ions, for example rare earth-doped fibers, in order to obtain active fibers to be used, for example, in fiber amplifiers or fiber laser applications. Both the fiber core and cladding are typically doped, so that the entire assembly (core and cladding) is effectively the same compound, e.g. an aluminosilicate, germanosilicate, phosphosilicate or borosilicate glass. Particularly for active fibers, pure silica is usually not a very suitable host glass, because it exhibits a low solubility for rare earth ions. This can lead to quenching effects due to clustering of dopant ions and accordingly aluminosilicates are much more effective in this respect.

Essentially there are three classes of components for oxide glasses: network formers, intermediates, and modifiers. The network formers (silicon, boron, germanium) form a highly cross-linked network of chemical bonds. The intermediates (titanium, aluminum, zirconium, beryllium, magnesium, zinc) can act as both network formers and modifiers, according to the glass composition. The modifiers (calcium, lead, lithium, sodium, potassium) alter the network structure; they are usually present as ions, compensated by nearby non-bridging oxygen atoms, bound by one covalent bond to the glass network and holding one negative charge to compensate for the positive ion nearby. Some elements can play multiple roles; e.g. lead can act both as a network former (Pb4+ replacing Si4+), or as a modifier.

The presence of non-bridging oxygen lowers the relative number of strong bonds in the material and disrupts the network, decreasing the viscosity of the melt and lowering the melting temperature. The alkaline metal ions are small and mobile; their presence in glass allows a degree of electrical conductivity, especially in molten state or at high temperature. Their mobility however decreases the chemical resistance of the glass, allowing leaching by water and facilitating corrosion. Alkaline earth ions, with their two positive charges and requirement for two non-bridging oxygen ions to compensate for their charge, are much less mobile themselves and also hinder diffusion of other ions, especially the alkalis.

Addition of lead(II) oxide lowers melting point, lowers viscosity of the melt, and increases refractive index. Lead oxide also facilitates solubility of other metal oxides and therefore is used in colored glasses which may form portions of an optical fiber cladding to improve identification of the fibre type and visibility. The viscosity decrease of lead glass melt is very significant (roughly 100 times in comparison with soda glasses) which allows easier removal of bubbles and working at lower temperatures, which can be beneficial in the formation of preforms and modifying glass characteristics to reduce differences in thermal processing temperatures.

Examples of heavy metal oxide glasses with high refractive indices include Bi2O3-, PbO—, Tl2O3-, Ta2O3-, TiO2-, and TeO2— containing glasses. Oxide glasses with low refractive indices may include glasses that contain one or more of the following compounds: 0-40 mole % of M2O where M is Li, Na, K, Rb, or Cs; 0-40 mole % of M′O where M′ is Mg, Ca, Sr, Ba, Zn, or Pb; 0-40 mole % of M₂O₃ where M″ is B, Al, Ga, In, Sn, or Bi; 0-60 mole % P2O5; and 0-40 mole % SiO2.

Fluorides:

Fluoride glasses are a class of non-oxide optical quality glasses composed of fluorides of various metals. Because of their low viscosity, it is very difficult to completely avoid crystallization while processing it through the glass transition (or drawing the fiber from the melt). Thus, although heavy metal fluoride glasses (HMFG) exhibit very low optical attenuation, they are typically difficult to manufacture, are fragile, and have poor resistance to moisture and other environmental attacks. Their best attribute is that they lack the absorption band associated with the hydroxyl (OH) group (3200-3600 cm-1), which is present in nearly all oxide-based glasses. However, they may be incorporated into preforms wherein other glasses are provided to give mechanical integrity, environmental resistance etc.

An example of a heavy metal fluoride glass is the ZBLAN glass group, composed of zirconium, barium, lanthanum, aluminum, and sodium fluorides which have applications as optical waveguides in both planar and fiber form, especially in the mid-infrared (2-5 μm) range.

Phosphates:

Phosphate glass constitutes a class of optical glasses composed of metaphosphates of various metals. Instead of the SiO4 tetrahedra observed in silicate glasses, the building block for this glass former is phosphorus pentoxide (P₂O₅), which crystallizes in at least four different forms. The most familiar polymorph comprises molecules of P₄O₁₀. Phosphate glasses can be advantageous over silica glasses for optical fibers with a high concentration of doping rare earth ions. A mix of fluoride glass and phosphate glass is fluorophosphate glass.

Chalcogenides:

The chalcogens, elements in group 16 of the periodic table, particularly sulfur (S), selenium (Se) and tellurium (Te), react with more electropositive elements, such as silver, to form chalcogenides. These are extremely versatile compounds, in that they can be crystalline or amorphous, metallic or semiconducting, as well as conductors of ions or electrons. In addition to a chalcogen element, chalcogenide glasses may include one or more of the following elements: boron, aluminum, silicon, phosphorus, gallium, germanium, arsenic, indium, tin, antimony, thallium, lead, bismuth, cadmium, lanthanum and the halides (fluorine, chlorine, bromide, iodine).

Chalcogenide glasses can be binary or ternary glasses, e.g., As—S, As—Se, Ge—S, Ge—Se, As—Te, Sb—Se, As—S—Se, S—Se—Te, As—Se—Te, As—S—Te, Ge—S—Te, Ge—Se—Te, Ge—S—Se, As—Ge—Se, As—Ge—Te, As—Se—Pb, As—S—Ti, As—Se—Tl, As—Te—Tl, As—Se—Ga, Ga—La—S, Ge—Sb—Se or complex, multi-component glasses based on these elements such as As—Ga—Ge—S, Pb—Ga—Ge—S, etc. The ratio of each element in a chalcogenide glass can be varied. For example, a chalcogenide glass with a suitably high refractive index may be formed with 5-30 mole % Arsenic, 20-40 mole % Germanium, and 30-60 mole % Selenium.

Amorphous Alloys:

In some instances, amorphous alloys with high refractive indices may be employed, examples of which include Al—Te and R—Te(Se) (R=alkali).

Metals:

In some instances, ductile metals may be employed, for example to form absorbers for polarizers or as elements within photonic crystal fibers, examples of which include gold, silver, platinum, and copper.

Micro-Structures:

Portions of optical fiber can optionally include mechanical structures such that they act as a photonic-crystal fiber (PCF) upon formation of the optical fiber/fiber taper/micro-taper. Such PCF's may include, but not be limited to, photonic-bandgap fibers that confine light by band gap effects, holey fibers which use air holes in their cross-sections, and hole-assisted fiber wherein waveguiding is achieved through a conventional higher-index core modified by the presence of air holes. Accordingly, such PCF properties may be varied during the controlled profiling of the fiber taper and/or micro-taper according to embodiments of the invention.

Nano-Particles:

Portions of high index-contrast fiber waveguides can be homogeneous or inhomogeneous. For example, one or more portions can include nano-particles (e.g., particles sufficiently small to minimally scatter light at guided wavelengths) of one material embedded in a host material to form an inhomogeneous portion. An example of this is a high-index polymer composite formed by embedding a high-index chalcogenide glass nano-particles in a polymer host. Further examples include CdSe and or PbSe nano-particles in an inorganic glass matrix.

Semiconductors:

A semiconductor refers to a material having an electrical conductivity value falling between that of a conductor and an insulator wherein the material may be an elemental material or a compound material. A semiconductor may include, but not be limited to, an element, a binary alloy, a tertiary alloy, and a quaternary alloy. Structures formed from a semiconductor or semiconductors may comprise a single semiconductor material, two or more semiconductor materials, a semiconductor alloy of a single composition, a semiconductor alloy of two or more discrete compositions, and a semiconductor alloy graded from a first semiconductor alloy to a second semiconductor alloy. A semiconductor may be undoped (intrinsic), p-type doped, n-typed doped, graded in doping from a first doping level of one type to second doping level of the same type, or grading in doping from a first doping level of one type to a second doping level of a different type. Semiconductors may include, but are not limited to, III-V semiconductors, such as those between aluminum (Al), gallium (Ga), and indium (In) with nitrogen (N), phosphorous (P), arsenic (As) and tin (Sb), including for example GaN, GaP, GaAs, InP, InAs, AN and AlAs; II-VI semiconductors; I-VII semiconductors; IV-VI semiconductors; IV-VI semiconductors; V-VI semiconductors; II-V semiconductors; and I-III-VI2 semiconductors; oxides; layered semiconductors; magnetic semiconductors; organic semiconductors; some group IV and VI elements and alloys such as silicon (Si), germanium (Ge), silicon germanium (SiGe) and silicon carbide (SiC); and charge-transfer complexes, either organic or inorganic.

Cladding—Coating Materials:

As noted above and as described below the inventors describe an approach to the design of photonic crystal fibers to provide cylindrical vector modes and orbital angular momentum modes for a range of applications. Within embodiments of the invention described below with respect to the Figures reference is made to one or more subsets of Photonic Crystal Fibers (PCFs) and Photonic Crystal Waveguides (PCWs) which overall are a class of optical fiber based on the properties of photonic crystals. Depending upon their design and manufacturing methodology the cladding—coating materials may be formed/provided within the stage of PCF manufacturing or applied subsequently. For example, considering standard silica optical fibers the doped core is formed within a preform with the cladding which is then drawn and the acrylate coating applied during the pulling process. Alternatively, with a glass coating this may also have been established during the formation of the preform from which the optical fiber is drawn (pulled). The cladding generally impacts optical performance of the optical fiber whereas the coating impacts environmental performance, reliability, etc. However, as a PCF may comprise a thin or no cladding, in principle, the boundaries of coating—cladding and core are not fixed within PCFs. Examples of cladding coating materials include, but are not limited to those listed below.

Glasses:

Glasses with lower index of refraction than the optical fiber materials to form a coating may include oxides, fluorides, phosphates, and chalcogenides as described above.

Polymers:

Polymers with lower index of refraction than the core optical fiber material may form part of the overall optical fiber design in addition to forming part of the mechanical and/or environmental protection of the final optical fiber/fiber taper/micro-taper/microwire. Further multiple polymers may be used in conjunction with each other to provide different aspects of these overall design goals as well as specific characteristics to the final fabricated devices. Amongst such polymeric materials, thermoplastic materials may be used according to embodiments of the invention which are not specifically defined and may include, for example, polyolefin-based resins, polystyrene-based resins, polyvinyl chloride-based resins, polyamide-based resins, polyester-based resins, polyacetal-based resins, polycarbonate-based resins, polyaromatic ether or thioether-based resins, polyaromatic ester-based resins, polysulfone-based resins, acrylate-based resins, etc.

The polyolefin-based resins include, for example, homopolymers and copolymers of α-olefins, such as ethylene, propylene, butene-1, 3-methylbutene-1, 3-methylpentene-1, 4-methylpentene-1; and copolymers of such α-olefins with other copolymerizable, unsaturated monomers. As specific examples of the resins, mentioned are polyethylene-based resins such as high-density, middle-density or low-density polyethylene, linear polyethylene, ultra-high molecular polyethylene, ethylene-vinyl acetate copolymer, ethylene-ethyl acrylate copolymer; polypropylene-based resins such as syndiotactic polypropylene, isotactic polypropylene, propylene-ethylene block or random copolymer; poly-4-methylpentene-1, etc.

The styrene-based resins include, for example, homopolymers and copolymers of styrene and α-methylstyrene; and copolymers thereof with other copolymerizable, unsaturated monomers. As specific examples of the resins, mentioned are general polystyrene, impact-resistant polystyrene, heat-resistant polystyrene (α-methylstyrene polymer), syndiotactic polystyrene, acrylonitrile-butadiene-styrene copolymer (ABS), acrylonitrile-styrene copolymer (AS), acrylonitrile-polyethylene chloride-styrene copolymer (ACS), acrylonitrile-ethylene-propylene rubber-styrene copolymer (AES), acrylic rubber-acrylonitrile-styrene copolymer (AAS), etc.

The polyvinyl chloride-based resins include, for example, vinyl chloride homopolymers and copolymers of vinyl chloride with other co-polymerizable, unsaturated monomers. As specific examples of the resins, mentioned are vinyl chloride-acrylate copolymer, vinyl chloride-methacrylate copolymer, vinyl chloride-ethylene copolymer, vinyl chloride-propylene copolymer, vinyl chloride-vinyl acetate copolymer, vinyl chloride-vinylidene chloride copolymer, etc. These polyvinyl chloride-based resins may be post-chlorinated to increase their chlorine content, and thus the post-chlorinated resins are also usable in the invention.

The polyamide-based resins include, for example, polymers as prepared by ring-cleaving polymerization of cyclic aliphatic lactams, such as 6-nylon, 12-nylon; polycondensates of aliphatic diamines and aliphatic dicarboxylic acids, such as 6,6-nylon, 6,10-nylon, 6,12-nylon; polycondensates of m-xylenediamine and adipic acid; polycondensates of aromatic diamines and aliphatic dicarboxylic acids; polycondensates of p-phenylenediamine and terephthalic acid; polycondensates of m-phenylenediamine and isophthalic acid; polycondensates of aromatic diamines and aromatic dicarboxylic acids; polycondensates of amino acids, such as 11-nylon, etc.

The polyester-based resins include, for example, polycondensates of aromatic dicarboxylic acids and alkylene glycols. As specific examples of the resins, mentioned are polyethylene terephthalate, polybutylene terephthalate, etc.

The polyacetal-based resins include, for example, homopolymers, such as polyoxymethylene; and formaldehyde-ethylene oxide copolymers and ethylene oxide.

The polycarbonate-based resins include, for example, 4,4′-dihydroxy-diarylalkane-based polycarbonates. Preferred are bisphenol A-based polycarbonates to be prepared by phosgenation of reacting bisphenol A with phosgene, or by interesterification of reacting bisphenol A with dicarbonates such asdiphenylcarbonate. Also usable are modified bisphenol A-based polycarbonates, of which the bisphenol A is partly substituted with 2,2-bis(4-hydroxy-3,5-dimethylphenyl)propane or 2,2-bis(4-hydroxy-3,5-dibromophenyl) propane; and flame-retardant, bisphenol A-based polycarbonates.

The polyaromatic ether or thioether-based resins have ether or thioether bonds in the molecular chain, and their examples include polyphenylene ether, styrene-grafted polyphenylene ether, polyether-ether-ketone, polyphenylene sulfide, etc.

The polyaromatic ester-based resins include, for example, polyoxybenzoyl to be obtained by polycondensation of p-hydroxybenzoic acid; polyarylates to be obtained by polycondensation of bisphenol A with aromatic dicarboxylic acids such as terephthalic acid and isophthalic acid, etc.

The polysulfone-based resins have sulfone groups in the molecular chain, and their examples include polysulfone to be obtained by polycondensation of bisphenol A with 4,4′-dichlorodiphenylsulfone; polyether-sulfones having phenylene groups as bonded at their p-positions via ether group and sulfone group, polyarylene-sulfones having diphenylene groups and diphenylene-ether groups as alternately bonded via sulfone group, etc.

The acrylate-based resins include, for example, methacrylate polymers and acrylate polymers. As the monomers for those polymers, for example, used are methyl, ethyl, n-propyl, isopropyl and butyl methacrylates and acrylates. In industrial use, typically used are methyl methacrylate resins.

The thermoplastic resin(s) may be used either singly or in combination. Equally the thermoplastic resin(s) may be used alone or in combination with one or more thermosetting materials. Of the thermoplastic resins mentioned above, in many applications the selected materials are polypropylene-based resins such as polypropylene, random or block copolymers of propylene with other olefins, and their mixtures, as well as acid-modified polyolefin-based resins as modified with unsaturated carboxylic acid or their derivatives.

The polyolefin-based resins for the acid-modified polyolefin-based resins include, for example, polypropylene, polyethylene, ethylene-α-olefin copolymers, propylene-ethylene random-copolymers, propylene-ethylene block-copolymers, ethylene-α-olefin copolymer rubbers, ethylene-α-olefin-non-conjugated diene copolymers (e.g., EPDM), and ethylene-aromatic monovinyl compound-conjugated diene copolymer rubber: 3. The α-olefins include, for example, propylene, butene-1, pentene-1, hexene-1, and 4-methylpentene-1, and one or more of these are usable either singly or as combined. Of those polyolefin-based resins, preferred are polypropylene-based or polyethylene-based resins containing copolymers, and more preferred are polypropylene-based resins.

Metals:

In some instances, ductile metals may be employed, for example to form electrical contacts or wettable areas for soldering the micro-taper to a structure, examples of which include gold, silver, platinum, and copper.

Additional Materials in Core-Cladding-Coating:

It would be evident to one skilled in the art that the combination of materials described above as potential candidates for fabricating optical fibers/fiber tapers/micro-tapers according to embodiments of the invention by providing the core, cladding, and coating materials may include materials that alter the mechanical, rheological and/or thermodynamic behavior of those portions of the fiber to which they are added. For example, one or more of the portions can include a plasticizer. Portions may include materials that suppress crystallization, or other undesirable phase behavior within the optical fiber. For example, crystallization in polymers may be suppressed by including a cross-linking agent (e.g., a photosensitive cross-linking agent). In other examples, a nucleating agent, such as TiO2 or ZrO2, can be included in the material.

Further, portions of the overall structure can also include compounds designed to affect the interface between adjacent portions in the optical fiber, for example between the core and cladding, or cladding and coating. Such compounds include adhesion promoters and compatibilizers. For example, organo-silane compounds promote adhesion between silica-based glasses and polymers, whilst phosphorus or P₂O₅ is compatible with both chalcogenide and oxide glasses, and may promote adhesion between portions formed from these glasses.

Optionally, the optical fiber can include additional materials specific to particular fiber waveguide applications such as for example a dopant or combination of dopants capable of interacting with an optical signal in the fiber to enhance absorption or emission of one or more wavelengths of light by the fiber. Alternatively, they can include nonlinear materials with high nonlinearity, such as for example materials with high Kerr nonlinear index (n₂).

Accordingly, amongst the techniques that can be employed for formation of a PCF/PCW preform and/or PCF/PCW coating include, but are not limited to chemical vapor systems such as modified chemical vapor deposition (MCVD), outside vapor deposition (OVD), plasma activated chemical vapor deposition (PCVD), plasma enhanced chemical vapor deposition (PECVD), chemical solution deposition (CSD), and vapor axial deposition (VAD) as well as epitaxial growth systems such as liquid phase epitaxy (LPE), metal organic chemical vapor deposition (MOVPE), and molecular beam epitaxy (MBE) and evaporation systems such thermal evaporation and electron beam evaporation. Other techniques that may be employed include sputtering, laser ablation, cathodic arc deposition, electrohydrodynamic deposition, and reactive sputtering. Alternatively, the materials may be spray coated, spin coated, or dip coated.

Optionally, in order to achieve a desired geometry, the preform may be formed from varying materials and/or concentrations longitudinally as well as radially. In many instances deposited layers of vaporized raw materials may be deposited in the form of a soot and soot layers may be consolidated with additional thermal processing stages which may be performed during the overall preform manufacturing process or upon completion of the deposition processes. In many instances a number of preforms (rods/tubes) may be combined in one or more bundles which are then drawn down using normal glassblowing and fiber drawing techniques as are known in the art of manufacture of optical fibers.

It would also be evident that preforms may be provided through a combination of one or more preforms with another element wherein the preform(s) are inserted into voids or openings within the other element. Such elements may be formed by the above identified techniques as well as others, including but not limited to, casting and extrusion. Alternatively, the preforms may contain voids containing a fluid such as air for example.

It would also be apparent that portions of the preform and/or the entire preform may be radially non-symmetric and have predetermined cross-sections to impart directional variation in the resulting optical fiber/fiber taper/micro-taper geometry to impart different refractive indices, confinement, effective index, etc. It would be evident that the preform may be fabricated within a single system in some instances or require the use of multiple systems in other instances according to the materials selected for the preform and their manufacturing parameters. It would be evident to one skilled in the art that other fiber designs other than those depicted within Figures may be employed without departing from the scope of the invention.

Hole Filling Materials:

In this specification the inventors describe an approach to the design of photonic crystal fibers to provide cylindrical vector modes and orbital angular momentum modes for a range of applications. Within embodiments of the invention described below with respect to the Figures reference is made to so-called “holey fibers” or ‘hole-assisted fibers” which employ a plurality of “holes” within the fiber. However, such fibers form subsets of photonic-crystal fiber (PCF) which overall are a class of optical fiber based on the properties of photonic crystals. However, it would be evident that the “holes” or “voids” within a holey PCF may be filled with a fluid. The common fluid within the prior art is air which has a dielectric constant substantially less than the dielectric constant of the PCF, e.g. silica (SiO₂), so the average index of refraction of the cladding may be less than the “core”, even though the same material is used for the “core” and “cladding”.

However, the voids or holes may be filled with a fluid that interacts with the light propagating in the PCF in a desired manner, e.g. in a linear or non-linear manner. Alternatively, they may be filled with a fluid such that they do not interact but their refractive index lies within a range for which a compatible material to form the PCF does not exist or does not meet design, performance, and/or manufacturing criteria for example. In each instance the PCF has part of the electric field of the electromagnetic radiation propagating within the PCF penetrating into the fluid through an evanescent wave.

Within embodiments of the invention the holes/voids may be filled with a fluid with a Raman active vibration but no absorption of the light propagating in the PCF. The linear index of refraction of such a fluid is therefore comparable to that of air or vacuum and thus does not perturb the linear propagation of light in the holey fiber. As a result, embodiments of the invention created with empty voids will generally also function properly in filled embodiment variations.

The holes in the PCF may be filled with fluids such as the gases hydrogen, deuterium, methane, deutero-methane and iodine, or indeed any other gases showing sufficient Raman gain and properties desired. Typically, it is expected that the fluids will be under pressure within the holes such as, for example, at pressures between 2 to 10 atmospheres. However, in other embodiments of the invention fluid filling may be slightly above atmospheric, atmospheric, slightly below atmospheric or low pressure without departing from the scope of the invention. Optionally, supercritical gases, where the pressure and temperature are high enough that there is no surface between liquid and gas and no surface tension, such as CO2 under high pressure, may be used. Liquids such as benzene, nitrobenzene, toluene, 1-bromonaphthalene, pyridine, cyclohexane, deuterated benzene, carbon disulfide, carbon tetrachloride, and chloroform may also be used. In general, Raman active fluids having a compound containing a vibrating group chosen from the list consisting of S—S, C—I, C—Br, C—SH, C—S, H—H, C—H, and C—C are anticipated as providing desired performance and are covered by the following claims.

Within other embodiments of the invention inert gases, inert fluids, active gases, and/or active fluids may be employed discretely or in combination. For example, a PCF may have a first predetermined subset filled with a first fluid and a second predetermined subset filled with a second fluid. Optionally, tubes may be pre-filled with a gas/fluid prior to their bundling and being drawn. Within other embodiments of the invention the holes may be filled post-drawing through high pressure soaking, sealing within a fluid environment, desorption of a coating, etc. Within some embodiments of the invention a fluid may be flowed into the holes and then “cured” in-situ through one or more processes such as UV photo-polymerization for example.

Material Compatibility Considerations:

When fabricating optical fibers according to embodiments of the invention it would be apparent that not every combination of materials, including but not limited to those outlined above, with desirable optical properties are necessarily suitable or compatible. Typically, one would select materials that are rheologically, thermo-mechanically, and physico-chemically compatible. However, it would also be apparent that these compatibility issues may change when considering highly nonlinear PCFs of a few centimeters or tens of centimeters in length to PCFs of hundreds of meters or tens of kilometers. Several criteria for selecting compatible materials will now be discussed.

Rheological:

A first criterion is to select materials that are rheologically compatible in that one selects materials that have viscosities within predetermined bounds over a broad temperature range, corresponding to the temperatures experienced during the different stages of fiber preform fabrication, optical fiber drawing, tapering, and actual system operation. As noted above these predetermined bounds for viscosity may vary with the materials themselves as well as the dimensions of the final fabricated optical device. Viscosity is the resistance of a fluid to flow under an applied shear stress and measured in Poise. Typically, materials are characterized by temperatures such as annealing point, softening point, working point, and melting point that are actually defined in terms of the given material having a specific viscosity. Accordingly, a material may have viscosities of 1013, 107.65, 104, and 102 Poise respectively at the annealing point, softening point, working point, and melting point. In addition to considering the rheological compatibility at these temperatures consideration should also be given to the change in viscosity as a function of temperature, i.e., the viscosity slope, so that stresses etc. are not introduced as the material transitions from one temperature range, e.g. the heat-brush process, to another, e.g. room temperature.

Temperature Expansion Coefficient:

A second selection criterion for materials is that the thermal expansion coefficients (TEC) of each material should be within predetermined limits at temperatures between the annealing temperatures and room temperature. In other words, as the fiber cools and its rheology changes from liquid-like to solid-like, both materials' volume should change by similar amounts. If the two materials TEC's are not sufficiently matched, a large differential volume change between two fiber portions can result in a large amount of residual stress buildup, which can cause one or more portions to crack and/or delaminate. Residual stress may also cause delayed fracture even at stresses well below the material's fracture stress.

For many materials, there are two linear regions in the temperature-length curve that have different slopes. There is a transition region where the curve changes from the first to the second linear region which is associated with a glass transition, where the behavior of a glass sample transitions from that normally associated with a solid material to that normally associated with a viscous fluid. The glass transition temperature is often taken as the approximate annealing point, where the viscosity is 1013 Poise, but in fact, typically measured glass transition temperatures are relative values and dependent upon the measurement technique employed.

Accordingly, the TEC can be an important consideration for obtaining fiber that is free from excessive residual stress, which can develop in the fiber during the draw process. Typically, when the TEC's of the two materials are not sufficiently matched; residual stress arises as elastic stress. The elastic stress component stems from the difference in volume contraction between different materials in the fiber as it cools from the glass transition temperature to room temperature (e.g., 25° C.). For embodiments in which the materials in the fiber become fused or bonded at any interface during the draw process, a difference in their respective TEC's will result in stress at the interface. One material will be in tension (positive stress) and the other in compression (negative stress), so that the total stress is zero. Moderate compressive stresses themselves are not usually a major concern for glass fibers, but tensile stresses are undesirable and may lead to failure over time.

It would also be apparent that whilst selecting materials having TEC's within predetermined limits can minimize an elastic stress component, residual stress can also develop from viscoelastic stress components. For example, consider a composite preform made of a glass and a polymer having different glass transition ranges (and different Tg's). During the processing the glass and polymer initially behave as viscous fluids and stresses due to the drawing process are relaxed instantly. However, subsequently the fiber rapidly loses heat, causing the viscosities of the fiber materials to increase exponentially, along with the stress relaxation time. Upon cooling to its Tg, the glass and polymer cannot practically release any more stress since the stress relaxation time has become very large compared with the draw rate. So, assuming the component materials possess different Tg values, the first material to cool to its Tg can no longer reduce stress, while the second material is still above its Tg and can release stress developed between the materials. Once the second material cools to its Tg, stresses that arise between the materials can no longer be effectively relaxed. Moreover, at this point the volume contraction of the second glass is much greater than the volume contraction of the first material (which is now below its Tg and behaving as a brittle solid). Such a situation can result sufficient stress buildup between the glass and polymer so that one or both of the portions mechanically fail. However, as there are two mechanisms, elastic and viscoelastic, then these mechanisms may be employed to offset one another. For example, materials constituting a fiber may naturally offset the stress caused by thermal expansion mismatch if mismatch in the materials Tg's results in stress of the opposite sign. Conversely, a greater difference in Tg between materials is acceptable if the materials' thermal expansion will reduce the overall permanent stress.

Thermal Stability:

A further selection criterion may be the thermal stability of candidate materials. A measure of the thermal stability is given by the temperature interval between the glass transition temperature and the temperature for onset of crystallization as a material cools slowly enough that each molecule can find its lowest energy state. Accordingly, a crystalline phase is a more energetically favorable state for a material than a glassy phase. However, a material's glassy phase typically has performance and/or manufacturing advantages over the crystalline phase when it comes to fiber waveguide applications. The closer the crystallization temperature is to the glass transition temperature, the more likely the material is to crystallize during drawing, which can be detrimental to the fiber, e.g., by introducing optical inhomogeneities into the fiber, which can increase transmission losses.

Annular Core Photonic Crystal Fibers

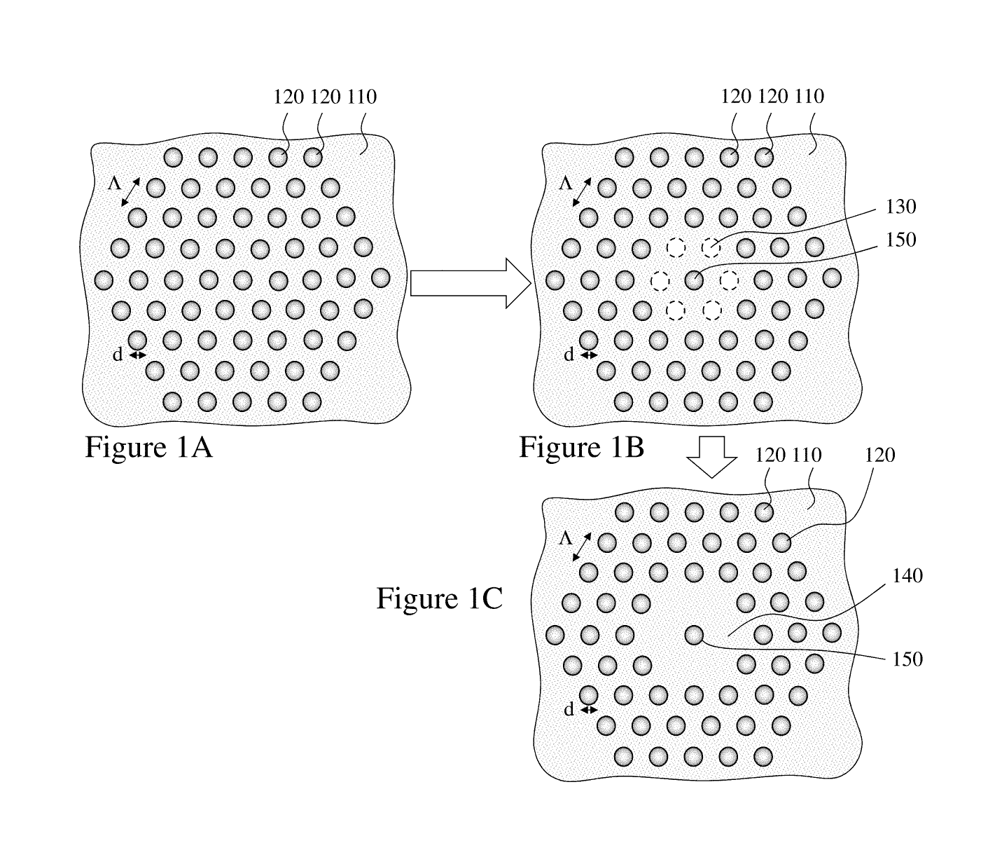

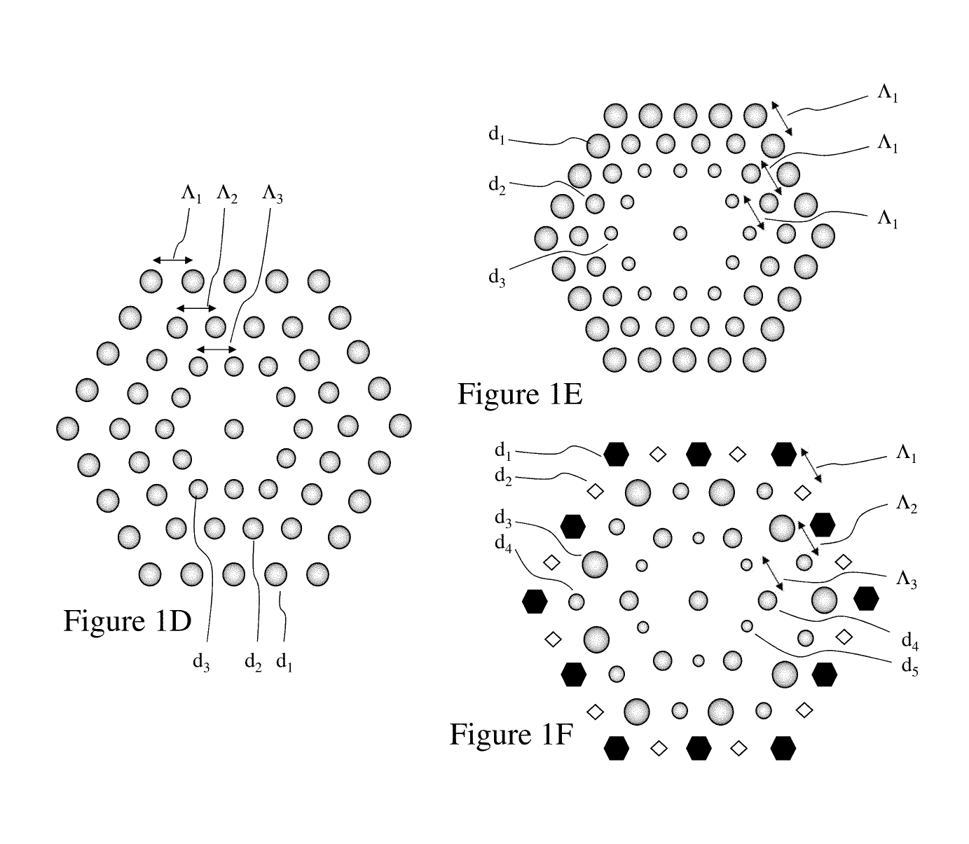

Referring to FIG. 1C there is depicted an annular core (AC) photonic crystal fiber (PCF) or AC-PCF according to an embodiment of the invention. Referring to FIG. 1A there is depicted a prior art triangular lattice PCF which is described as a triangular matrix of Holes 120 within a Medium 110 with the lattice defined via a hole diameter, d, and a hole pitch, Λ. Referring to FIG. 1B an AC-PCF according to an embodiment of the invention is depicted wherein an annular ring of 6 Voids 130 are depicted around a central Hole 120, denoted as Core Hole 150 for differentiation. In FIG. 1B the six Holes 120 have been replaced with Voids 130 to provide an annular ring with modified parameters relative to Medium 110 around a Core Hole 150. This annular ring of Voids 130 is then surrounded by Holes 120.

FIG. 1C depicts a further AC-PCF according to an embodiment of the invention is depicted wherein an Annular Ring 140 of the Medium 110 is depicted around a Core Hole 150. In FIG. 1C the six Holes 120 have been replaced with Medium 110 to provide an annular ring of Medium 110 around a Core Hole 150. This annular ring of Medium 110 is then surrounded by Holes 120. Accordingly, Voids 130 may provide a design range between that of a prior art triangular PCF and an annular core PCF according to an embodiment of the invention with only Medium 110 within the annular ring. At this limit where the Voids 130 are replaced with Medium 110 the refractive index distribution may be viewed as similar to that within the prior art of a ring core fiber wherein a ring of high refractive index material is disposed around a central core of lower index material and within a cladding of this lower index material.

Now referring to FIGS. 1D to 1F respectively there are depicted AC-PCF geometries according to embodiments of the invention wherein the Core Hole 150, Holes 120, and Annular Ring 140 which are not explicitly identified but evident and identifiable by cross-reference to FIGS. 1A to 1C respectively. Accordingly, considering FIG. 1D the three annular rings of Holes 120 surrounding the Core Hole 150 and Annular Ring 140 vary from the outer ring to the inner ring in both hole diameter, d₁, d₂, d₃, and pitch, Λ₁, Λ₂, Λ₃. In contrast, in FIG. 1E the three annular rings of Holes 120 surrounding the Core Hole 150 and Annular Ring 140 vary from the outer ring to the inner ring in hole diameter, d₁, d₂, d₃, but are of constant pitch, Λ₁. Within FIG. 1F the three rings are characterised as follows:
outer ring comprising hexagonal and diamond geometries with dimensions d₁, d₂ respectively at pitch Λ₁;
middle ring comprising circular geometries with dimensions d₃, d₄ respectively at pitch Λ₂; and
inner ring comprising circular geometries with dimensions d₅, d₆ respectively at pitch Λ₃.

In this manner the modal properties of an AC-PCF according to an embodiment of the invention may be obtained through a combination of geometries within the AC-PCF. Such properties, for example, including flattening the chromatic dispersion of the group velocity or improving fiber bending losses. In some embodiments of the invention such complex geometries may be manufactured in a single process sequence or employ multiple process sequences.

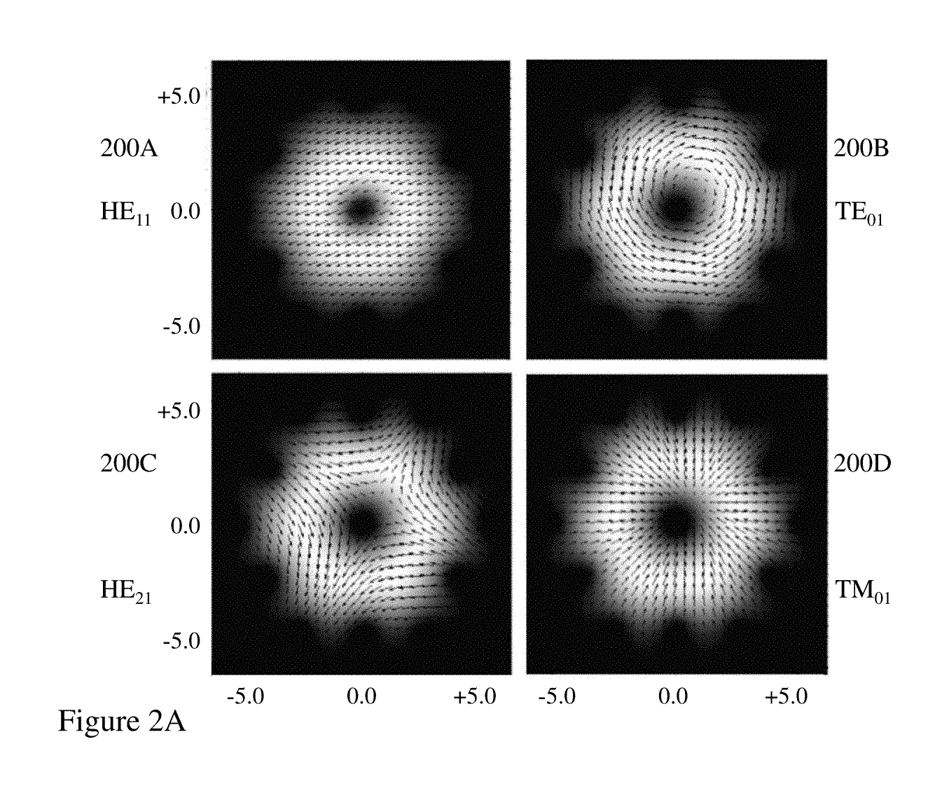

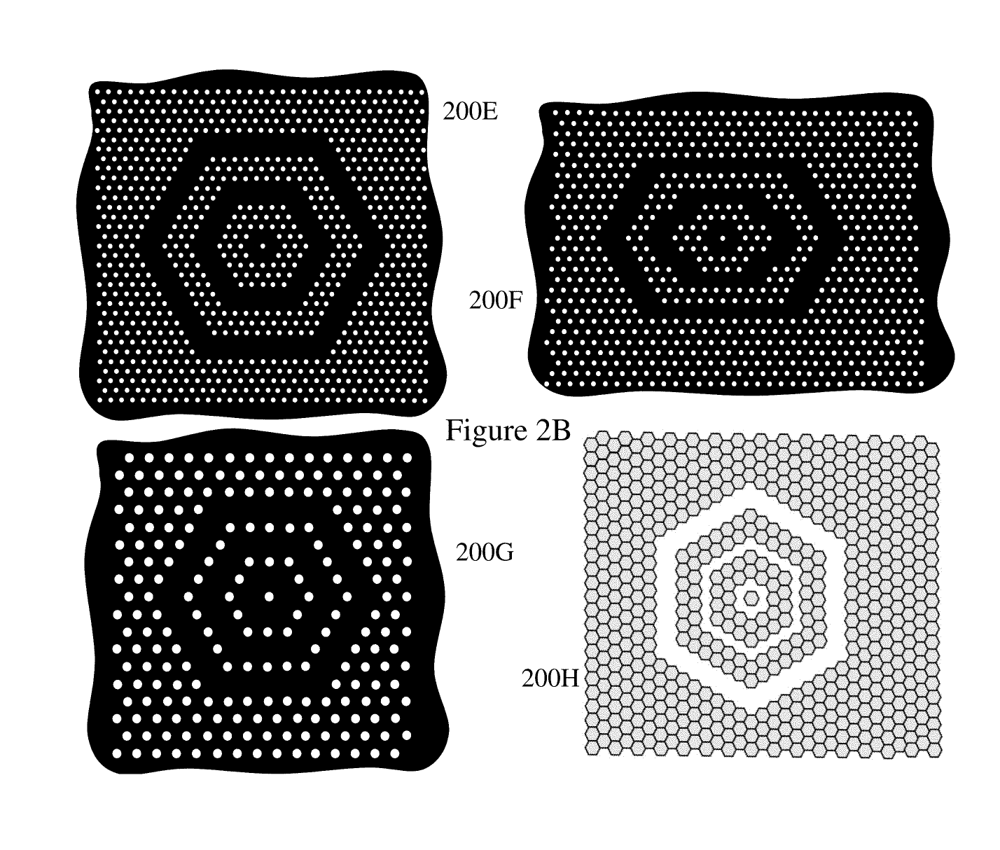

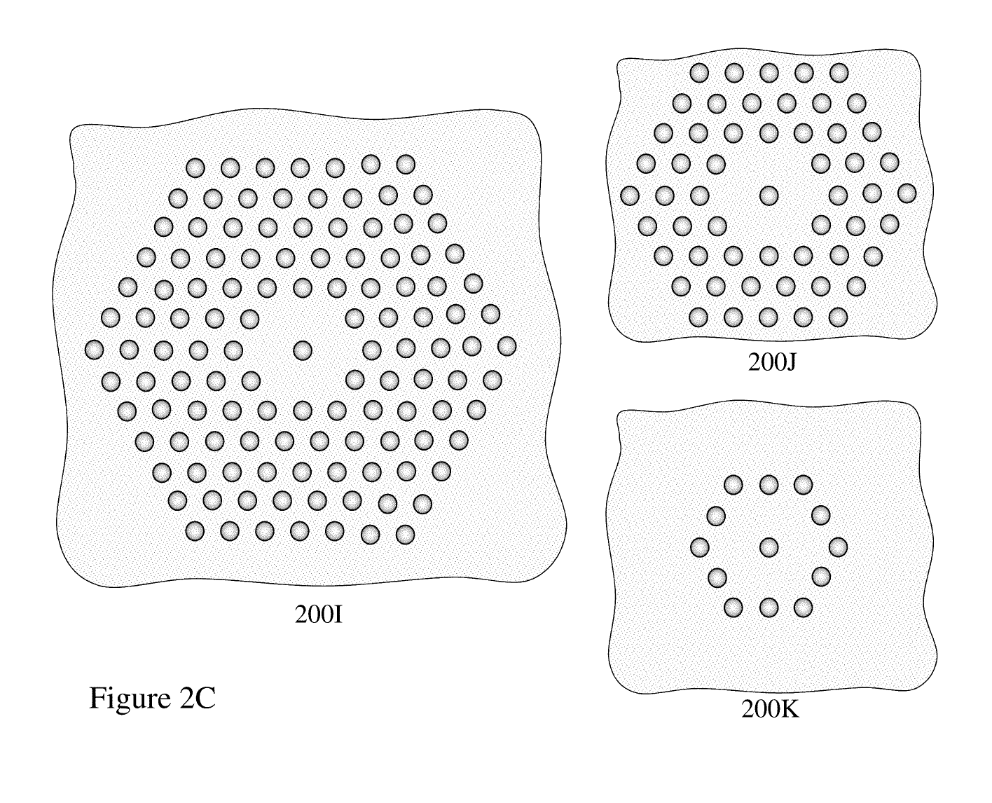

Accordingly, the waveguide features of the AC-PFC depicted in third image 100C of FIG. 1 are similar as depicted in FIG. 2A wherein the AC-PFC supports a fundamental HE₁₁ mode as depicted in first image 200A with an annular intensity profile. The AC-PFC also supports other cylindrical vector modes of the LP₁₁ group such as TE₀₁, HE₂₁, and TM₀₁ for example which are depicted in second to fourth images 200B to 200D respectively in FIG. 2A.

Now referring to FIG. 2B there are depicted first to fourth AC-PCF variants 200E to 200H respectively. First and second variants 200E and 200F respectively employ circularly symmetric holes within triangular lattices with second and third rings of “omitted holes” leaving the medium. In first variant 200E the structure is radially symmetric driven by the 6-fold hexagonal symmetry inherent within the triangular lattice. However, second variant 200F is vertically/laterally symmetric without the full symmetry. Third AC-PCF variant 200F is symmetric and has 3 annular rings of constant width through the omission of a single “ring” of holes whereas first variant 200E has varying width rings formed by the omission of 1, 2, and 2 “rings” of holes respectively. Finally, fourth variant 200H is again symmetric from the underlying lattice geometry and exploits 3 annular rings of 1, 1, and 2 omitted holes which are now hexagonal in geometry. It would be evident that the variations all represent annular core PCF designs but that the optical performance of these will vary through different (d, Λ) such as evident with first and third AC-PCF variants as well as different “annular ring” dimensions etc. as well as from employing “circular holes” or “hexagonal holes.” It would be evident that as with second image 100B in FIG. 1 relative to third image 100C in FIG. 1 that first to fourth AC-PCF variants 200E to 200H respectively may equally have been presented with “Voids”, such as Voids 130 in FIG. 1 of different properties to the holes and medium, for example Hole 110 and Medium 110 in FIG. 1 respectively. In this situation the design flexibility increases further as the “voids” may vary from one annular ring to another.

It would also be evident that the AC-PCF according to embodiments of the invention may allow the designer flexibility in the number of “rings” of holes as depicted in FIG. 2C. Here, first to third ring AC-PCF variants 200I to 200K are depicted with five, three, and one ring of holes around the annular ring of the medium. A discussed previously the sites within the triangular lattice absent holes, e.g. Holes 120 in FIG. 1, within the lattice may be populated with voids, e.g. Voids 130 in FIG. 1, in other embodiments of the invention rather than just the medium, e.g. Medium 110 in FIG. 1. It would be evident that in other embodiments of the invention the holes and voids, e.g. Holes 120 and Voids 130 in FIG. 1, may be varied in geometry to include, but not be limited to, circles, ellipses, squares, hexagons, regular polygons, and irregular polygons. In some embodiments of the invention the geometry may be fixed within the AC-PCF but vary in dimensions d and/or Λ within a ring or group of rings. In other embodiments the geometry may vary from ring to ring or between groups of rings. Further, in other embodiments of the invention the triangular lattice may be replaced with another lattice such as rhombic, square, hexagonal, rectangular, parallelogrammic, and equilateral triangular (strictly subset of hexagonal being 3-fold reflectional symmetric versus six-fold for hexagonal).

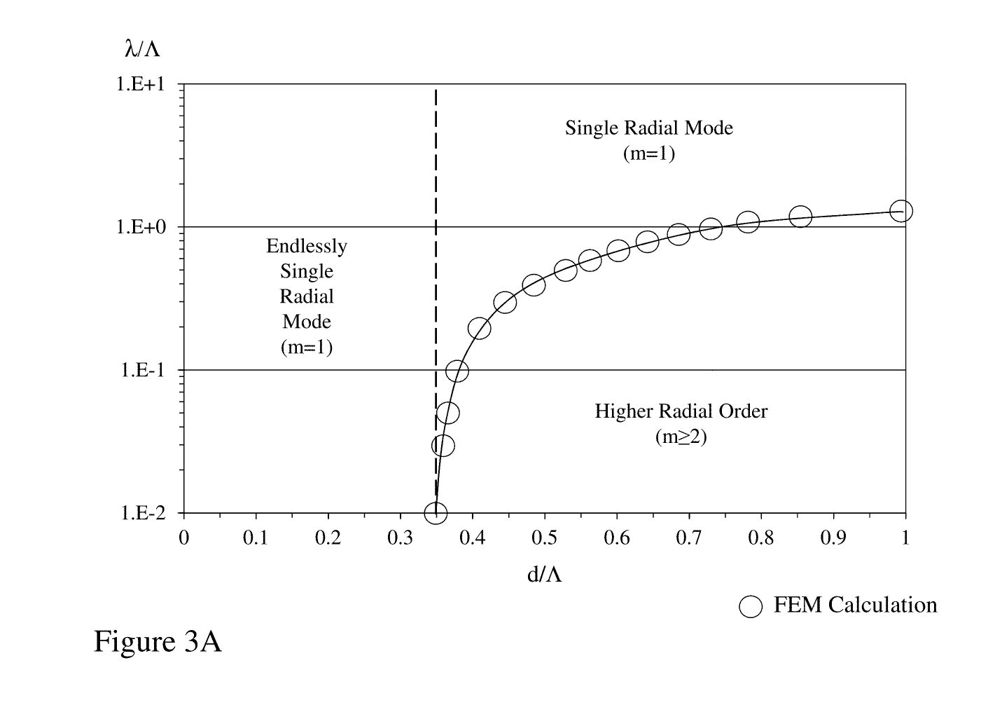

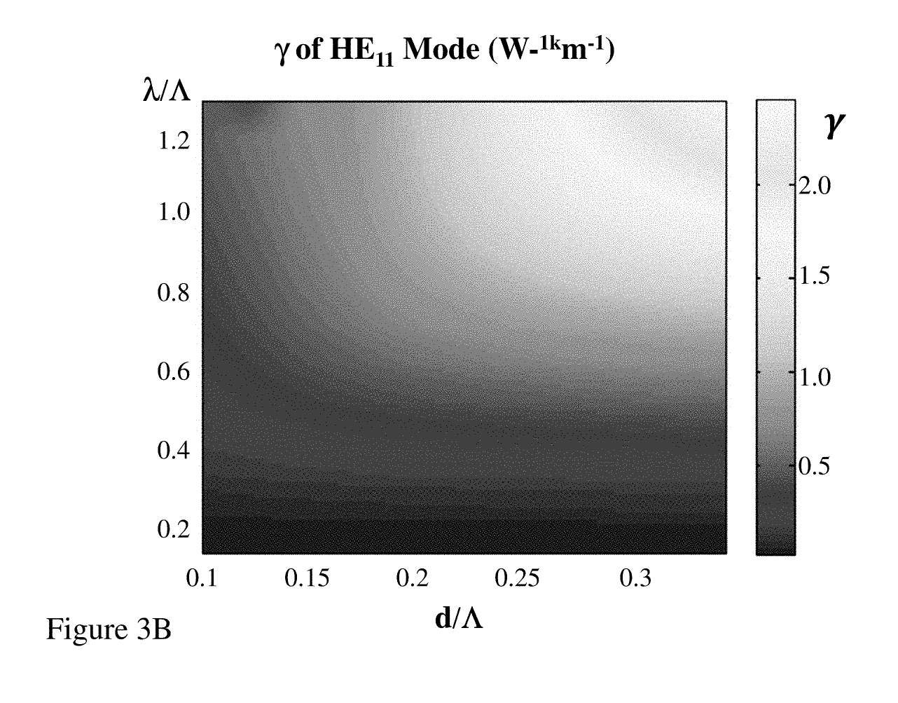

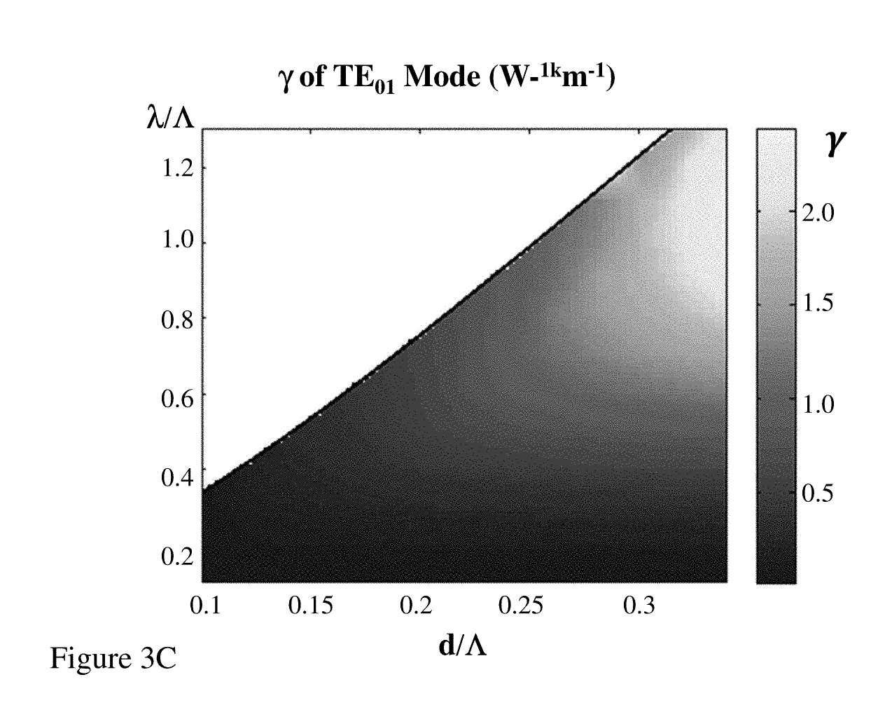

Accordingly, the photonic designer is given significant design flexibility in exploiting holes, voids, and surrounding medium in the design of an AC-PCF according to embodiments of the invention. Considering, for example the AV-PRF depicted in FIG. 1 with third image 100C and second ring AC-PCF variant 200J with 3 rings of holey cladding then referring to FIG. 3A there is plotted the different regimes of operation of the AC-PCF as a function of d/Λ and λ/Λ. Accordingly, at large d/Λ the waveguides vary between single radial order mode (m=1) and multiple higher order radial modes (m≥2) as the wavelength λ reduces, i.e. λ/Λ becomes smaller. However, below d/Λ=0.35 the AC-PDF becomes endlessly single radial order guiding in which case it exclusively supports m=1 for all wavelengths, i.e. all λ/Λ.

The ability to enforce modes with m=1 in an AC-PCF mitigates issues related to mode coupling with unwanted higher-radial-order modes (m≥2). The latter feature is also desirable, among others, in space-division multiplexing (SDM) applications using cylindrical vector modes and OAM modes, where modal multiplexing (MUX) and/or demultiplexing (DMUX) operations generally assume a single radial intensity distribution.

Within the prior art PCFs have been demonstrated and/or predicted to offer outstanding tunability for both enhancing and/or suppressing optical nonlinearities and for shaping the chromatic dispersion of the PCF. Referring to FIG. 3B there are depicted simulation results for the nonlinear parameter, γ, for an endlessly-single-radial-order silica AC-PCF at λ=1.55 um propagating an HE₁₁ mode. It would be evident that the value of γ increases with both d/Λ and λ/Λ, i.e. for higher modal confinement (which increases with the air-to-glass ratio) and as the design approaches the sub-wavelength waveguiding limit, respectively. Accordingly, the relatively low complexity of the AC-PCF coupled with its tunable design regime and options offers designers a platform for endlessly-single-radial-order mode fibers supporting high nonlinear performance as well as compatibility with packaging, MUX-DMUX etc.

Now referring to FIG. 3C there are depicted simulation results for an annular TE₀₁ mode of an AC-PCF with silica composition at λ=1550 nm within the endless single radial order regime. Accordingly, it can be seen that again the value of γ increases with both d/Λ and) λ/Λ, i.e. for higher modal confinement (which increases with the air-to-glass ratio).

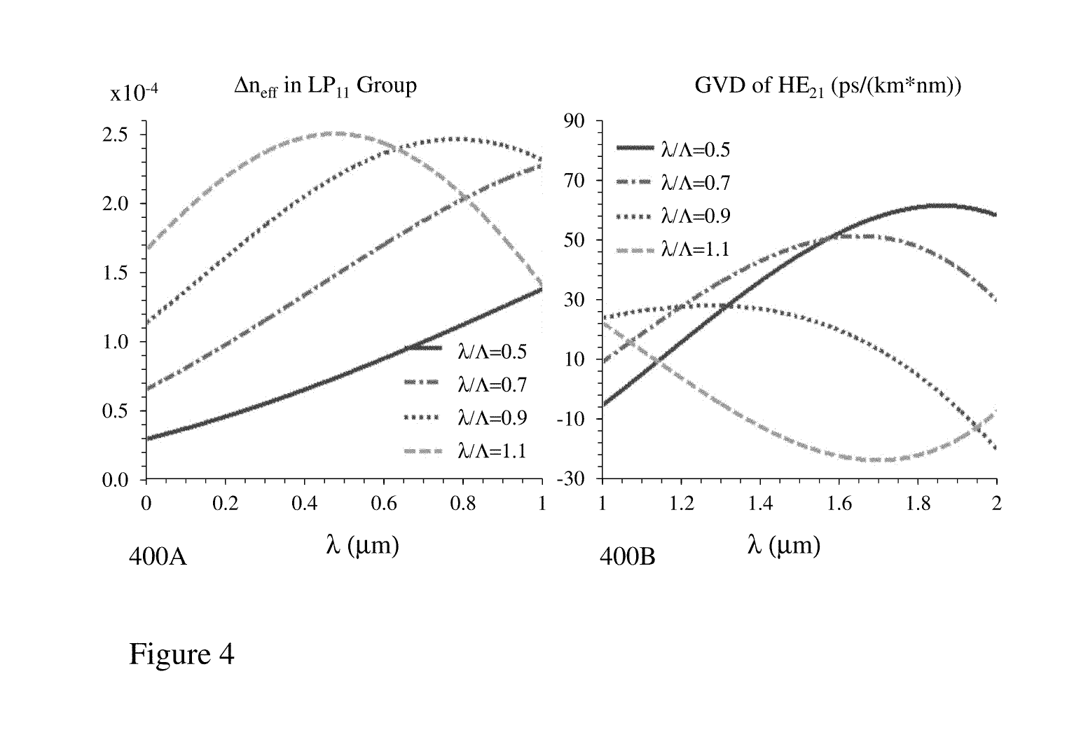

Within an optical fiber the stability of propagating OAM modes depends on lifting the modal degeneracy of their constituent cylindrical vector modes. In particular, the HE/EH eigenmodes that support OAM states must be sufficiently separated from adjacent eigenmodes. Within the prior art a common rule of thumb is to achieve a minimum intermodal separation of the effective indices of Δn_{eff}≥10⁻⁴, such as within prior art polarization-maintaining fibers. Accordingly, the inventors modelled AC-PCF optical fibers resulting in the results depicted in FIG. 4 wherein in first graph 400A the value of Δn_{eff} for the HE₂₁ mode is plotted relative to the TE₀₁ and TM₀₁ modes for selected configurations of silica AC-PCF with relative hole diameter d/Λ=0.33 whilst their corresponding group velocity dispersion (GVD) curves are depicted in second graph 400B in FIG. 4.

As evident from first graph 400A in FIG. 4 it is possible to maintain the Δn_{eff}≥10⁻⁴ “rule of thumb” condition over a broad wavelength range. Moreover, it is clear from the few sample configurations modelled and their results in second graph 400B that these AC-PCF fibers according to embodiments of the invention support extensive engineering of the GVD, which is a key factor in many nonlinear optical processes dependent on phase matching of waves. Accordingly, it is anticipated that AC-PCF fibers will enable optical components and optical systems within a wide range of applications with and without nonlinear performance.

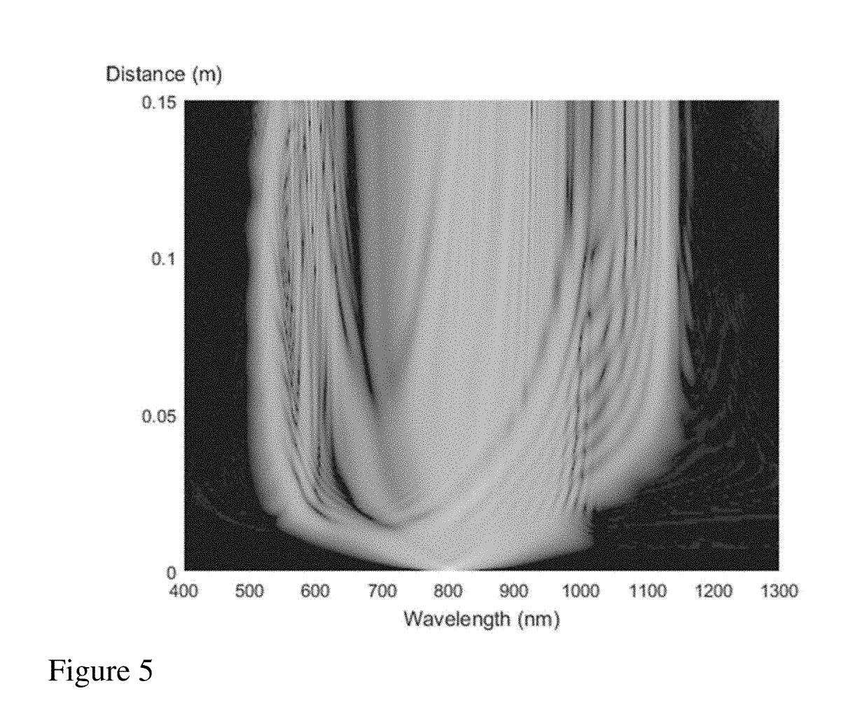

The endlessly single-radial order regime of the AC-PCF and its optical non-linearities within the AC-PCF can be exploited in order to generate a supercontinuum source exhibiting a mono-annular output beam profile at all wavelengths. A supercontinuum source being a broadband source of coherent light. Accordingly, referring to FIG. 5 there is depicted graphically the evolution of a supercontinuum emission from a 15 cm (0.15 meter or approximately 5.9 inches) long silica AC-PCF with λ=1.3 μm and d/A=0.34 pumped with Gaussian pulses of 60 fs duration at λ=800 nm with 1 nJ energy. Accordingly, it can be seen that the supercontinuum source extends from approximately λ=550 nm to λ=1150 nm, i.e. has an emission spectrum approximately 600 nm wide.

Within the embodiments of the invention described and depicted supra in respect of FIGS. 1 to 5 a single optical transmission structure has been described and presented comprising Annular Core Photonic Crystal Fibers (AC-PCFs). Accordingly, the assumption has been that the combination of holes and/or voids within the medium provide a single optical fiber which implies to one of skill in the art a circularly symmetric strand with the Annular Core centrally positioned within the PCF. However, an AC-PCF may be manufactured with multiple Annular Cores optically isolated within a common strand or alternatively multiple Annular Core Photonic Crystal Waveguides (AC-PCWs) may be formed in other geometries within or upon a substrate, silicon wafer, etc. Within other embodiments of the invention an AC-PCW may be formed with a non-circularly symmetric geometry to the medium such as square, rectangular, trapezoidal, etc. within which the Annular Core structure is disposed.

It would also be evident to skilled in the art that whilst the specification in terms of background and description have been presented with respect to telecommunications that the invention may also be applied to optical fiber structures within other fields including, but not limited to, instrumentation, optical sources, sensors and biomedicine.

The above-described embodiments of the present invention are intended to be examples only. Alterations, modifications and variations may be effected to the particular embodiments by those of skill in the art without departing from the scope of the invention, which is defined solely by the claims appended hereto.

1. A device comprising:
a structure having a predetermined cross-section and extending perpendicular to the cross-section formed from a material;
a plurality of holes extending longitudinally through the structure, each of the plurality of holes having its position defined by a two-dimensional lattice centered upon a predetermined point within the structure; wherein
an annular ring symmetrically disposed relative to the predetermined point within the structure is formed by not providing holes within a region defined as the annular ring such that the annular ring has a higher refractive index than the regions inside and outside the annular ring; and
the structure comprising the plurality of holes and annular ring operatively provides an endless single radial order regime for the propagation of optical signals over a first predetermined wavelength range.

2. The device according to claim 1, wherein
the annular ring is one of a plurality of annular rings.

3. The device according to claim 1, wherein
the diameter and pitch of the plurality of holes are such that, in operation, the optical signals propagating within the structure have a mono-annular intensity profile over the first predetermined wavelength range.

4. The device according to claim 1, wherein
the two-dimensional lattice is either an equilateral triangular lattice or a hexagonal lattice having a constant pitch;
the plurality of holes comprises:
a first centrally disposed hole at the predetermined point within the structure; and
three groups of holes disposed around the first centrally disposed hole at the locations defined by the two-dimensional lattice at distances of two, three, and four pitches respectively from the first centrally disposed hole, wherein
the annular ring is the region defined between the first centrally disposed hole and the three groups of holes; and
the plurality of holes each having a cross-sectional shape that is one of:
a circular cross-sectional shape having a same diameter for the first centrally disposed hole and the three groups of holes;
a circular cross-sectional shape having a first diameter for the first centrally disposed hole, a second diameter for the group of holes at distance of two pitches, a third diameter for the group of holes at distance of three pitches, and a fourth diameter for the group of holes at distance of four pitches, where the first diameter is shorter than the second diameter, the second diameter is shorter than the third diameter and the third diameter is shorter than the fourth diameter.

5. A device comprising:
a medium formed from a first material having optical transmission properties within a predetermined wavelength range;
a first structure disposed at a predetermined point within the medium and extending along an axis of the medium;
a plurality of second structures disposed around the first structure, each of the plurality of second structures being disposed at a predetermined location defined by a two-dimensional lattice centered upon the first structure;
a plurality of third structures disposed around the plurality of second structures, each of the plurality of third structures being disposed at a predetermined location defined by the two-dimensional lattice.

6. (canceled)

7. The device according to claim 5, wherein
either:
the first structure and the plurality of third structures are openings within the device filled with a second material; and
the plurality of second structures are openings within the device filled with at least one of the first material and a third material;
or
the two-dimensional lattice is a triangular lattice;
the first structure is a circular hole filled with air;
the plurality of second structures are filled with the first material and form a single ring around the first structure;
the plurality of third structures are circular holes filled with air and form three rings around the plurality of second structures.

8. (canceled)

9. The device according to claim 5, wherein
at least one of:
the ratio of a diameter of the holes to a pitch of the holes within the two-dimensional lattice is established to support an endlessly single radial order regime within the device;
and
the two-dimensional lattice is triangular;
the ratio is less than 0.35;
the first structure and the plurality of third structures are circular holes filled with air; and
the first material is silica.

10. (canceled)

11. The device according to claim 5, wherein
the two-dimensional lattice is a triangular lattice;
the first structure is a circular hole filled with a predetermined fluid having an optical non-linearity;
the plurality of second structures are filled with the first material and form a single ring around the first structure;
the plurality of third structures are circular holes filled with the predetermined fluid and form three rings around the plurality of second structures.

12-14. (canceled)

15. The device according to claim 1, wherein
the two-dimensional lattice is either an equilateral triangular lattice or hexagonal lattice comprising a plurality of sets of lattice points away from the predetermined point within structure and having a pitch that increases away from the predetermined point within the structure for each sequentially disposed set of lattice points of the plurality of sets of lattice points;
the plurality of holes comprises:
a first centrally disposed hole at the predetermined point within the structure having a first geometry;
a first group of holes disposed around the first centrally disposed hole at the locations defined by the two-dimensional lattice for a second sequential set of the lattice points of the plurality of sets of lattice points;
a second group of holes disposed around the first centrally disposed hole at the locations defined by the two-dimensional lattice for a third sequential set of the lattice points of the plurality of sets of lattice points; and
a third group of holes disposed around the first centrally disposed hole at the locations defined by the two-dimensional lattice for a fourth sequential set of the lattice points of the plurality of sets of lattice points;
the annular ring is the region between the first centrally disposed hole and the first group of holes; and
the holes within any one of the first group of holes, the second group of holes, and the third group of holes having a cross-sectional shape that is one of:
a circular cross-sectional shape having a same diameter;
a circular cross-sectional shape and comprise a first subset having a first diameter and a second subset having a second diameter; and
comprise a third subset having a first geometry and a first lateral dimension and a fourth subset having a second geometry and a second lateral dimension.

16. The device according to claim 1, wherein
the two-dimensional lattice is either an equilateral triangular lattice or hexagonal lattice having a constant pitch;
the plurality of holes comprises:
a first centrally disposed hole at the predetermined point within the structure; and either
five groups of holes disposed around the first centrally disposed hole at the locations defined by the two-dimensional lattice at distances of two to six pitches respectively from the first centrally disposed hole;
or
a group of holes disposed around the first centrally disposed hole at the locations defined by the two-dimensional lattice at a distance of two pitches from the first centrally disposed hole;
the annular ring is the region between the first centrally disposed hole and the three rings of holes; and
the plurality of holes are circular and of same diameter.

17. The device according to claim 1, wherein
the two-dimensional lattice is one of rhombic, square, hexagonal, rectangular, parallelogrammic, and equilateral triangular.

18. The device according to claim 1, wherein
the annular ring comprises the material forming the structure and a plurality of voids extending longitudinally through the structure, each void having its position defined by the two-dimensional lattice centered upon a predetermined point within the structure and having different optical properties to both the material forming the structure and a second material filling the plurality of holes; wherein
the plurality of holes have one or more first geometries selected from circles, ellipses, squares, hexagons, regular polygons, and irregular polygons; and
the plurality of voids have one or more second geometries selected from circles, ellipses, squares, hexagons, regular polygons, and irregular polygons.

19. The device according to claim 1, wherein
the plurality of holes are filled with one or more fluids, each fluid of the one or more fluids interacting with optical signals propagating within the structure in a non-linear manner; and
at least one of:
a fluid of the one or more fluids is a Raman active fluid containing a vibrating group selected from one of S—S, C—I, C—Br, C—SH, C—S, H—H, C—H, and C—C;
a fluid of the one or more fluids is a supercritical gas under the appropriate pressure at the operating temperature of the device;
a fluid of the one or more fluids is under pressure within the holes, the pressure being between 2 and 10 atmospheres.

20. The device according to claim 5, wherein
the two-dimensional lattice is either an equilateral triangular lattice or hexagonal lattice comprising a plurality of sets of lattice points away from the predetermined point within structure and having a pitch that increases away from the predetermined point within the structure for each sequentially disposed set of lattice points of the plurality of sets of lattice points;
the first structure is a first hole at the predetermined point within the structure having a first geometry;
the plurality of second structures are filled with the first material and define an annular ring in conjunction with the medium between the first structure and the plurality of third structures;
the plurality of third structures comprises:
a first group of holes disposed around the first centrally disposed hole at the locations defined by the two-dimensional lattice for a second sequential set of the lattice points of the plurality of sets of lattice points;
a second group of holes disposed around the first centrally disposed hole at the locations defined by the two-dimensional lattice for a third sequential set of the lattice points of the plurality of sets of lattice points; and
a third group of holes disposed around the first centrally disposed hole at the locations defined by the two-dimensional lattice for a fourth sequential set of the lattice points of the plurality of sets of lattice points;
the holes within any one of the first group of holes, the second group of holes, and the third group of holes are one of:
circular and of constant diameter;
circular and comprise a first subset having a first diameter and a second subset having a second diameter; and
comprise a third subset having a first geometry and a first lateral dimension and a fourth subset having a second geometry and a second lateral dimension.

21. The device according to claim 5, wherein
the two-dimensional lattice is either an equilateral triangular lattice or a hexagonal lattice having a constant pitch;
the first structure is a first hole at the predetermined point within the structure having a first geometry;
the plurality of second structures are filled with the first material and define an annular ring in conjunction with the medium between the first structure and the plurality of third structures;
the plurality of third structures comprises:
either
five groups of holes disposed around the first centrally disposed hole at the locations defined by the two-dimensional lattice at distances of two to six pitches respectively from the first centrally disposed hole;
or
a group of holes disposed around the first centrally disposed hole at the locations defined by the two-dimensional lattice at a distance of two pitches from the first centrally disposed hole; and
the plurality of holes are circular and of same diameter.

22. The device according to claim 5, wherein
the two-dimensional lattice is one of rhombic, square, hexagonal, rectangular, parallelogrammic, and equilateral triangular.

23. The device according to claim 5, wherein
the plurality of second structures have different optical properties to both the first material forming the structure and a second material filling the plurality of holes; wherein
the first structure is filled with a first material and has a geometry selected from a circle, an ellipse, a square, a hexagon, a regular polygon, and an irregular polygon;
the plurality of second structures are filled with a second material and have one or more first geometries selected from circles, ellipses, squares, hexagons, regular polygons, and irregular polygons; and
the plurality of third structures are filled with a third material and have one or more second geometries selected from circles, ellipses, squares, hexagons, regular polygons, and irregular polygons.

24. A method comprising:
drawing a device from a former, the device comprising
a medium formed from a first material having optical transmission properties within a predetermined wavelength range;
a first structure disposed at a predetermined point within the medium and extending along an axis of the medium;
a plurality of second structures disposed around the first structure, each of the plurality of second structures being disposed at a predetermined location defined by a two-dimensional lattice centered upon the first structure; and
a plurality of third structures disposed around the plurality of second structures, each of the plurality of third structures being disposed at a predetermined location defined by the two-dimensional lattice; wherein
the plurality of holes are filled with one or more fluids; and
at least one of:
a fluid of the one of more fluids is disposed within one or more tubes which are bundled together with one or preforms of the material to form the former which is drawn to provide the device;
a fluid of the one or more fluids are disposed within the plurality of holes once the device has been drawn, each fluid disposed within its subset of the plurality of holes by one of high pressure soaking, sealing the holes within an environment of the fluid, and desorption of a predetermined coating deposited within the holes; and
a fluid of the one or more fluids is flowed into the holes and then cured in-situ once the device has been drawn.

25. The method according to claim 24, wherein
at least one of the first structure and the plurality of third structures are filled with one or more fluids, each fluid of the one or more fluids interacting with optical signals propagating within the structure in a non-linear manner; and
at least one of:
a fluid of the one or more fluids is a Raman active fluid containing a vibrating group selected from one of S—S, C—I, C—Br, C—SH, C—S, H—H, C—H, and C—C;
a fluid of the one or more fluids is a supercritical gas under the appropriate pressure at the operating temperature of the device;
a fluid of the one or more fluids is under pressure within the holes, the pressure being between 2 and 10 atmospheres.

26. The method according to claim 24, wherein
at least one of the first structure and the plurality of third structures are filled with one or more fluids; wherein
at least one of:
a fluid of the one of more fluids is disposed within one or more tubes which are bundled together with one or preforms of the material and the composite assembly drawn to provide the device;
a fluid of the one or more fluids are disposed within the plurality of holes once the device has been formed, each fluid disposed within its subset of the plurality of holes by one of high pressure soaking, sealing the holes within an environment of the fluid, and desorption of a predetermined coating deposited within the holes; and
a fluid of the one or more fluids is flowed into the holes and then cured in-situ.
